(19) United States
(12) Patent Application Publication
(10) Pub. No.: US 2004/0062304 A1
(43) Pub. Date: Apr. 1, 2004

(54) Spatial quality of coded pictures using layered scalable video bit streams

(76) Inventors: Catherine Mary Dolbear, Oxford (GB); Paola Marcella Hobson, Alton (GB)

Correspondence Address: MOTOROLA, INC., 1303 EAST ALGONQUIN ROAD, IL01/3RD, SCHAUMBURG, IL, 60196

(21) Appl. No.: 10/332,674

(22) PCT Filed: Jul. 9, 2001
(86) PCT No.: PCT/EP01/07885

(30) Foreign Application Priority Data
Jul. 11, 2000 (GB) 0017035.7

(51) Int. Cl. H04N 7/12

(52) U.S. Cl. 375/240.1; 375/240.12

(57) ABSTRACT

A method of optimising the quality of a B picture by temporal scalability for an enhancement layer of a video bit stream, wherein the B picture B_{0.5} is predicted based on an SNR enhancement picture EI₀ appearing in the highest enhancement layer of the bit stream. A prediction is achieved using foward prediction based on an enhanced picture already appearing in the same enhancement layer. As a result, information contained in the enhanced picture is not wasted.

### FIELD OF THE INVENTION

This invention relates to video signals, and in particular to layered scalable video bit streams.

### BACKGROUND OF THE INVENTION

A ‘video signal’ consists of a sequence of images. Each image is referred to as a ‘frame’. When a video signal is transmitted from one location to another, it is typically transmitted as a sequence of pictures. Each frame may be sent as a single picture, however the system may need to send more than one picture to transmit all the information in one frame.

Increasingly, video signals are being transmitted over radio communication links. This transmission may be over a communication path of very limited bandwidth, for example over a communication channel between a portable or mobile radio device and a base station of a cellular communications system.

One method of reducing the bandwidth required for transmission of video is to perform particular processing of the video signal prior to transmission. However, the quality of a video signal can be affected during coding or compression of the video signal. For this reason, methods have been developed to enhance the quality of the received signal following decoding and/or decompression.

It is known, for example, to include additional ‘layers’ of transmission, beyond simply the base layer in which pictures are transmitted. The additional layers are termed ‘enhancement layers’. The basic video signal is transmitted in the base layer. The enhancement layers contain sequences of pictures that are transmitted in addition to the basic set of pictures. These additional pictures are then used by a receiver to improve the quality of the video. The pictures transmitted in the enhancement layers may be based on the difference between the actual video signal and the video bit stream after it has been encoded by the transmitter.

The base layer of video transmission typically contains two types of picture. The first is an ‘Intracoded’ picture, which is often termed an I-picture. The important feature of an I-picture is that it contains all the information required for a receiver to display the current frame of the video sequence. When it receives an I-picture, the receiver can display the frame without using any data about the video sequence that it has received previously.

A P-picture contains data about the differences between one frame of the video sequence and a previous frame. Thus a P-picture constitutes an ‘update’. When it receives a P-picture, a receiver displays a frame that is based on both the P-picture and data that it already holds about the video stream from previously received pictures.

If a video system employs one or more enhancement layers, then it can send a variety of different types of picture in the enhancement layer. One of these types is a ‘B-picture’. A ‘B-picture’ differs from both I- and P-pictures. A ‘B-picture’ is predicted based on information from both a picture that precedes the B-picture in time in the video stream and one that follows it. The B-picture is said to be ‘bi-directionally predicted’. This is illustrated in FIG. 1 of the appended drawings.

A B-picture is predicted based on pictures from the layer below it. Thus a system with a base layer and a single enhancement layer will predict ‘B-pictures’ based on earlier and later pictures in the base layer, and transmit these B-pictures in the enhancement layer. A notable feature of B-pictures are that they are disposable—the receiver does not have to have them in order to display the video sequence. In this sense they differ from P-pictures, which are also predicted, but are necessary for the receiver to reconstruct the video sequence. A further difference lies in the fact that B-pictures cannot serve as the basis for predicting further pictures.

The pictures transmitted in the enhancement layers are an optional enhancement, since the transmission scheme always allows a receiver to re-construct the transmitted video stream using only the pictures contained in the base layer. However, any systems that have sufficient transmission bandwidth can be arranged to use these enhancement layers. Typically, the base layer requires a relatively low transmission bandwidth, and the enhancement layers require a greater bandwidth. An example of typical transmission bandwidths is given in connection with the discussion of the invention as illustrated in FIGS. 8 and 9.

This hierarchy of base-layer pictures and enhancement pictures, partitioned into one or more layers, is referred to as a layered scalable video bit stream.

In a layered scalable video bit stream, enhancements can be added to the base layer by one or more of three techniques. These are:

(i) Spatial scalability. This involves increasing the resolution of the picture.

(ii) SNR scalability. This involves including error information to improve the Signal to Noise Ratio of the picture.

(iii) Temporal scalability. This involves including extra pictures to increase the frame rate.

The term ‘hybrid scalability’ implies using more than one of the techniques above in encoding of the video stream.

Enhancements can be made to the whole picture. Alternatively, the enhancements can be made to an arbitrarily shaped object within the picture, which is termed ‘object-based’ scalability.

The temporal enhancement layer is disposable, since a receiver can still re-construct the video stream without the pictures in the enhancement layer. In order to preserve the disposable nature of the temporal enhancement layer, the H.263+ standard dictates that pictures included in the temporal scalability mode must be bi-directionally predicted (B) pictures. This means that they are predicted based on both the image that immediately precedes them in time and on the image which immediately follows them.

If a three layer video bit stream is used, the base layer (layer 1) will include intra-coded pictures (I pictures). These I-pictures are sampled, coded or compressed from the original video signal pictures. Layer 1 will also include a plurality of predicted inter-coded pictures (P pictures). In the enhancement layers (layers 2 or 3 or more), three types of picture may be used for scalability: bi-directionally predicted (B) pictures; enhanced intra (EI) pictures; and enhanced predicted (EP) pictures. EI pictures may contain SNR enhancements to pictures in the base layer, but may instead be a spatial scalability enhancement.

The three basic methods of scalability will now be explained in more detail.

Temporal Scalability

Temporal scalability is achieved using bi-directionally predicted pictures, or B-pictures. These B-pictures are predicted from previous and subsequent reconstructed pictures in the reference layer. This property generally results in improved compression efficiency as compared to that of P pictures.

B pictures are not used as reference pictures for the prediction of any other pictures. This property allows for B-pictures to be discarded if necessary without adversely affecting any subsequent pictures, thus providing temporal scalability.

FIG. 1 shows a sequence of pictures plotted against time on the x-axis. FIG. 1 illustrates the predictive structure of P and B pictures.

SNR Scalability

The other basic method to achieve scalability is through spatial/SNR enhancement. Spatial scalability and SNR scalability are equivalent, except for the use of interpolation as is described shortly. Because compression introduces artifacts and distortions, the difference between a reconstructed picture and its original in the encoder is nearly always a nonzero-valued picture, containing what can be called the coding error. Normally, this coding error is lost at the encoder and never recovered. With SNR scalability, these coding error pictures can also be encoded and sent to the decoder. This is shown in FIG. 2. These coding error pictures produce an enhancement to the decoded picture. The extra data serves to increase the signal-to-noise ratio of the video picture, hence the term SNR scalability.

FIG. 3 illustrates the data flow for SNR scalability. The vertical arrows from the lower layer illustrate that the picture in the enhancement layer is predicted from a reconstructed approximation of that picture in the reference (lower) layer.

FIG. 2 shows a schematic representation of an apparatus for conducting SNR scalability. In the figure, a video picture F₀ is compressed, at 1, to produce the base layer bit stream signal to be transmitted at a rate r₁ kbps. This signal is decompressed, at 2, to produce the reconstructed base layer picture F₀′.

The compressed base layer bit stream is also decompressed, at 3, in the transmitter. This decompressed bit stream is compared with the original picture F₀, at 4, to produce a difference signal 5. This difference signal is compressed, at 6, and transmitted as the enhancement layer bit stream at a rate r₂ kbps. This enhancement layer bit stream is decompressed at 7 to produce the enhancement layer picture F₀″. This is added to the reconstructed base layer picture F₀′ at 8 to produce the final reconstructed picture F₀′″.

If prediction is only formed from the lower layer, then the enhancement layer picture is referred to as an EI picture. An EI picture may provide an SNR enhancement on the base layer, or may provide a spatial scalability enhancement.

It is possible, however, to create a modified bi-directionally predicted picture using both a prior enhancement layer picture and a temporally simultaneous lower layer reference picture. This type of picture is referred to as an EP picture or “Enhancement” P-picture.

The prediction flow for EI and EP pictures is shown in FIG. 3. Although not specifically shown in FIG. 3, an EI picture in an enhancement layer may have a P picture as its lower layer reference picture, and an EP picture may have an I picture as its lower-layer enhancement picture.

For both EI and EP pictures, the prediction from the reference layer uses no motion vectors. However, as with normal P pictures, EP pictures use motion vectors when predicting from their temporally-prior reference picture in the same layer.

Spatial Scalability

The third and final scalability method is spatial scalability, which is closely related to SNR scalability. The only difference is that before the picture in the reference layer is used to predict the picture in the spatial enhancement layer, it is interpolated by a factor of two. This interpolation may be either horizontally or vertically (1-D spatial scalability), or both horizontally and vertically (2-D spatial scalability). Spatial scalability is shown in FIG. 4.

The three basic scalability modes, temporal, SNR and spatial scalability, can be applied to any arbitrarily shaped object within the picture, including the case where the object is rectangular and covers the whole frame. This is known as object based scalability.

SNR scalability is more efficient at lower bit rates, and temporal scalability more efficient when there is a higher bandwidth available. To take advantage of this fact, a hybrid scalability model has been developed. This is described in “H.263 Scalable Video Coding and Transmission at Very Low Bitrates”, PhD Dissertation, Faisal Ishtiaq, Northwestern University, Illinois, USA, December 1999. This model consists of a base layer (layer 1), followed by an SNR enhancement layer (layer 2), then a further enhancement layer (layer 3). In layer 3, a dynamic choice is made between SNR or temporal mode. This choice between SNR enhancement and temporal enhancement is made based on four factors: the motion in the current picture, the separation between pictures, the peak signal to-noise-ratio (PSNR) gain from layer 2 to layer 3 if SNR scalability were to be chosen, and the bit rate available for layer 3.

FIG. 5 shows an example of a three layer video bit stream using hybrid SNR/temporal scalability along the lines described in the prior art document mentioned above.

When SNR scalability mode is selected in layer 3, there is a spatial quality improvement over the layer 2 picture at the same temporal position. If temporal scalability is selected for the following picture, the extra information from the old EI picture in layer 3 is not used. This means that if layer 3 has a much greater bit rate allocation than layer 2, the layer 3 EI picture may contain significant additional information, which is wasted.

Furthermore, if a B picture is encoded in layer 3, it is bi-directionally predicted from the previous and subsequent layer 2 picture (EI pictures), and therefore is of a lower spatial quality than neighbouring pictures. These neighbouring pictures may have been chosen to include SNR enhancement information instead. This is particularly noticeable when the base and enhancement layer 2 have low bit rates allocated to them, and enhancement layer 3 has a much greater bit rate allocation. Hence, not only is a low spatial quality B picture undesirable for the viewer, but a continual variation in video spatial quality between pictures is also particularly noticeable. However, since the human visual system considers motion to be relatively more significant than the spatial quality of an individual picture, it is still important to include B pictures, especially when a video is to be viewed in slow motion.

A problem solved by the invention is how to encode B pictures so that they are not of noticeably worse spatial quality than the enhancement intra (EI) pictures provided by SNR scalability mode in enhancement layer 3, without exceeding the target bit rate for any of the layers.

A prior art arrangement is known from published European Patent Application EP-A-0739140. EP-A-0739140 shows an encoder for an end-to-end scalable video delivery system. The system employs base and enhancement layers.

A further prior art arrangement is known from published International Patent Application number WO-A-9933274. WO-A-9933274 shows a scalable predictive coder for video. This system also employs base and enhancement layers.

### SUMMARY OF THE INVENTION

The present invention provides a method of optimising the spatial quality of a picture produced by temporal scalability for an enhancement layer of a video bit stream, wherein the picture is predicted based on a picture appearing in the highest enhancement layer of the bit stream. In this way, if extra information is already known in the highest enhancement layer, it is not wasted.

Preferably the picture is predicted based only on one picture appearing in the highest enhancement layer of the bit stream. In theory, however, the prediction could take place based on additional information contained elsewhere in the bit stream.

The present invention further provides a method of optimising the spatial quality of a picture produced by temporal scalability for an enhancement layer of a video bit stream, wherein the picture is predicted based on a single picture already appearing in the same enhancement layer of the bit stream. This is quite different to the prior art, wherein pictures produced by temporal scalability are predicted based on information contained in two pictures, the previous and subsequent pictures in the lower enhancement layers.

The prediction of the picture by temporal scalability is preferably achieved using forward prediction from a previous EI picture in the same enhancement layer.

If an appropriate picture is not available in the same enhancement layer for a forward prediction to be made, the method of the present invention may result in a bi-directional prediction being carried out using previous and subsequent lower layer pictures.

The present invention is particularly applicable to a three layer system, with the picture produced by temporal scalability according to the present invention appearing in the third layer, namely the second enhancement layer.

A method according to the present invention may be used when a video bit stream is prepared for transmission, perhaps via a wireless or mobile communications system, using a hybrid SNR/temporal scalability method. Spatial and/or object based scalability may, however, also be involved, either with or without SNR scalability, as appropriate, and the scalability can be applied to arbitrarily shaped objects as well as to rectangular objects.

The present invention also provides a system which is adapted to implement the method according to the present invention described and claimed herein.

### BRIEF DESCRIPTION OF THE DRAWINGS

FIG. 1 is a schematic illustration of B picture prediction dependencies;

FIG. 2 is a schematic representation of an apparatus and method for undertaking SNR scalability;

FIG. 3 is a schematic illustration showing a base layer and an enhancement layer produced using SNR scalability;

FIG. 4 is a schematic illustration showing a base layer and an enhancement layer produced using spatial scalability;

FIG. 5 is a schematic illustration of a three layer hybrid SNR/temporal scalability application according to the prior art;

FIG. 6 is a schematic illustration of a three layer hybrid SNR/temporal scalability application according to the present invention wherein a picture in the highest possible enhancement layer is used for B picture prediction;

FIG. 7 is a flow diagram depicting the essence of an algorithm according to the present invention;

FIG. 8 is a graph of PSNR for each encoded picture of a QCIF “Foreman” sequence with B picture prediction from EI pictures in layer 2 according to the prior art method;

FIG. 9 is a graph of PSNR for each encoded picture of a QCIF “Foreman” sequence with B picture prediction from EI pictures in layer 3 according to the present invention;

FIG. 10 illustrates the general scheme of a wireless communications system which could take advantage of the present invention; and

FIG. 11 illustrates a mobile station (MS) which uses the method according to the present invention.

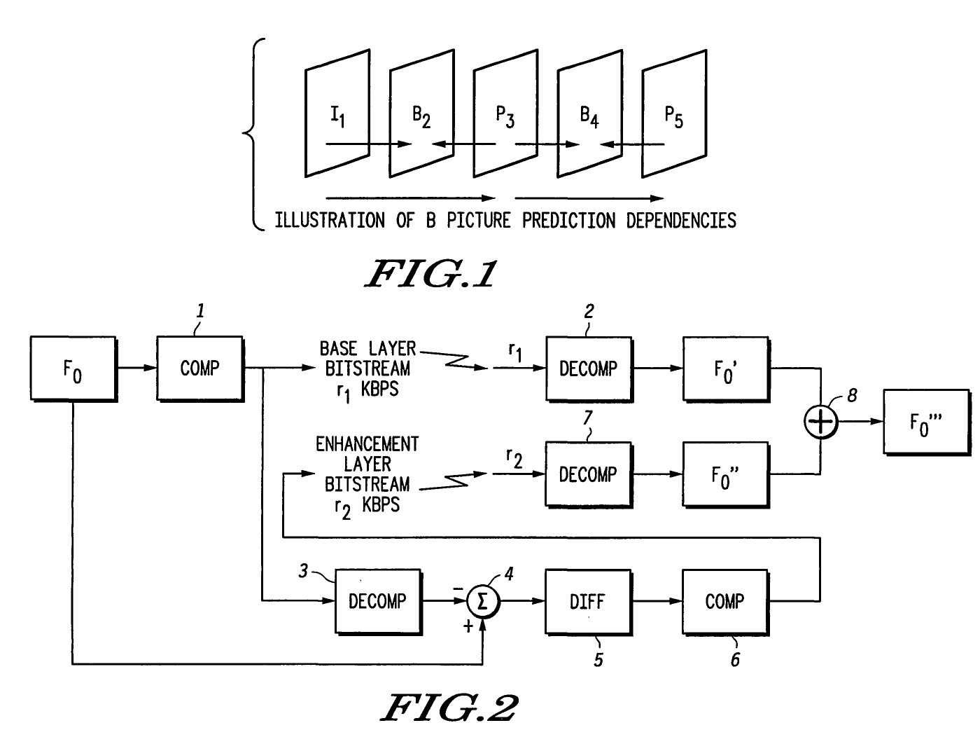

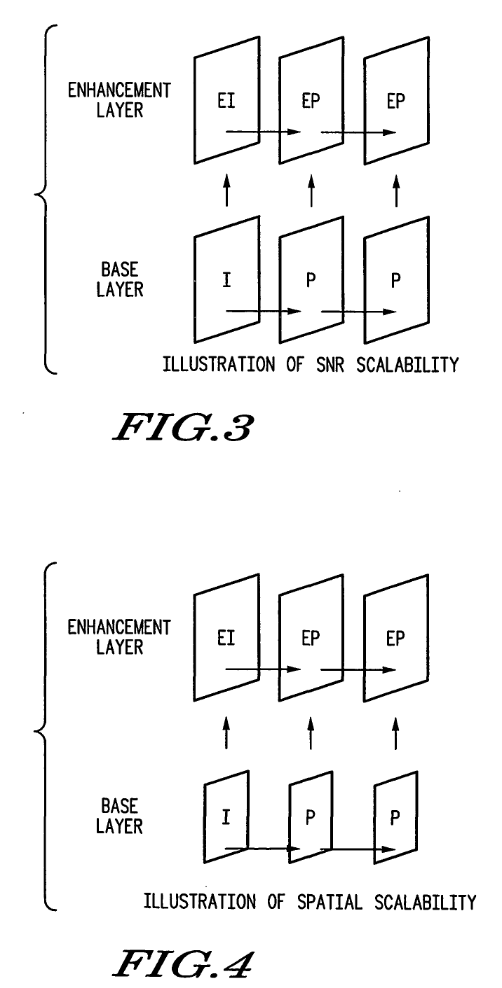

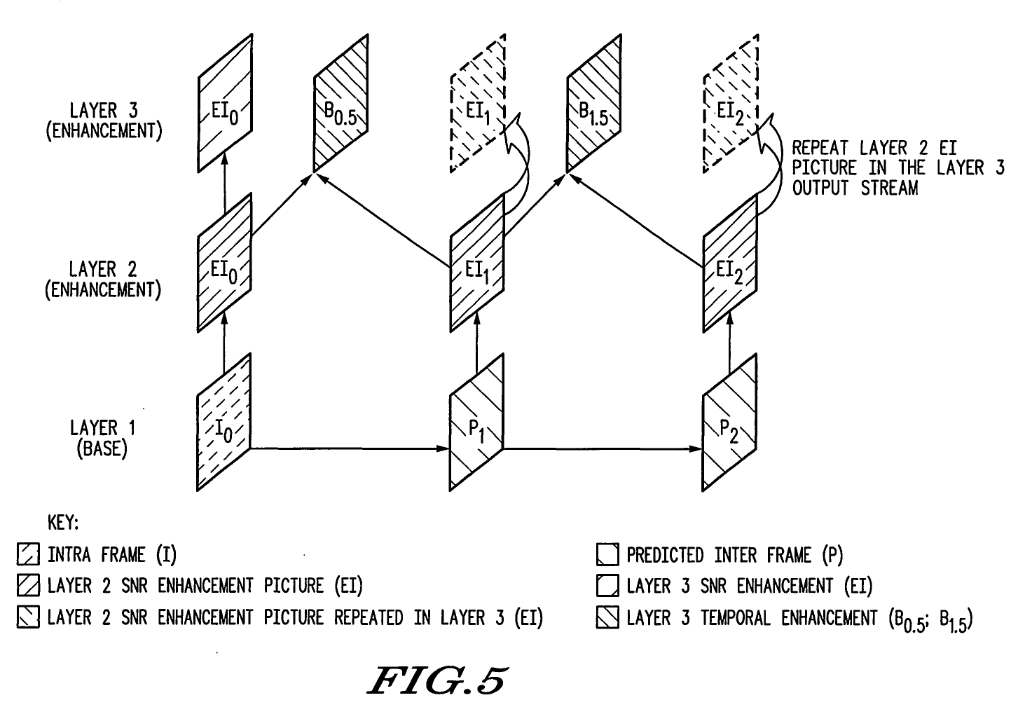

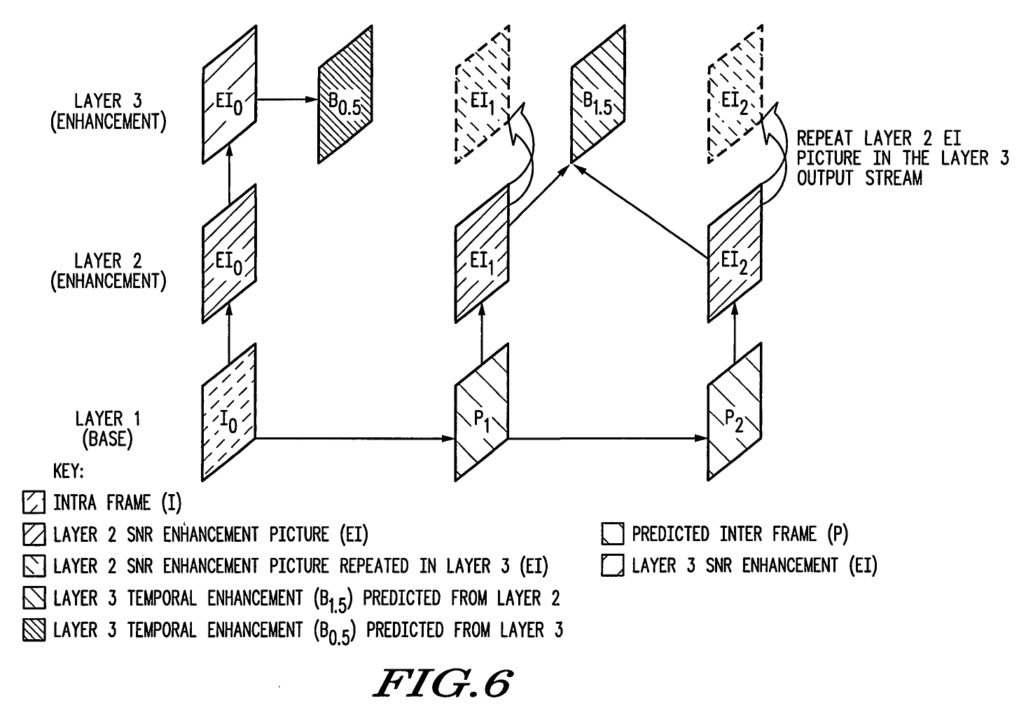

### DESCRIPTION OF A PREFERRED EMBODIMENT

The present invention is now described, by way of example only, with reference to FIGS. 6 to 11 of the accompanying drawings.

FIG. 6 shows a three layer video bit stream, wherein layer 1 is a base layer and layers 2 and 3 are enhancement layers.

The first enhancement layer, layer 2, is produced using SNR enhancement based on the pictures appearing in layer 1. The layer 3 enhancement is achieved based on a hybrid SNR/temporal scalability method. The choice between SNR scalability and temporal scalability is made based on factors similar to those disclosed in the PhD Dissertation of Faisal Ishtiaq discussed above.

As will be seen in FIG. 6, two B pictures are shown. The first, B_{0.5}, results due to the algorithm of the method of the present invention forcing the use of a forward prediction mode based on the preceding layer 3 EI picture (EI₀). The preceding layer 3 EI picture (EI₀) was produced by SNR enhancement of the corresponding layer 2 picture. The idea of forcing a forward prediction to produce a B picture is, as far as the inventors are aware, completely novel.

Furthermore, the production of picture B_{0.5} would appear to be somewhat contradictory to prior art approaches in this environment, because a B picture is by normal definition “bi-directionally predicted” based on two pictures. This does not occur in this embodiment of the present invention.

With regard to the second B picture appearing in FIG. 6, B_{1.5}, this is produced based on a bi-directional prediction using the previous and subsequent layer 2 EI pictures (EI₁ and EI₂). This is because layer 3 does not include an enhanced version of the layer 2 picture EI₁, and a forward prediction cannot therefore be made. The layer two picture EI₁ is simply repeated in layer 3, without any enhancement. Likewise as shown in FIG. 6, the layer 2 picture EI₂ is simply repeated without any enhancement in layer 3.

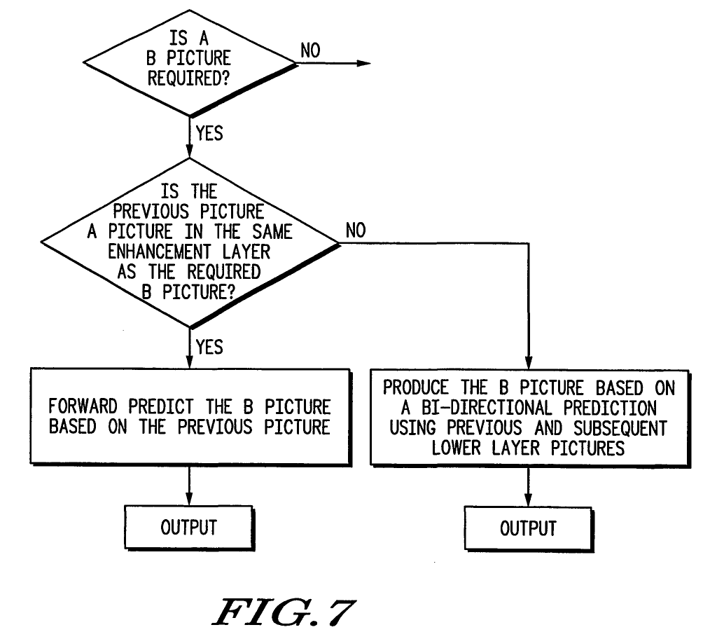

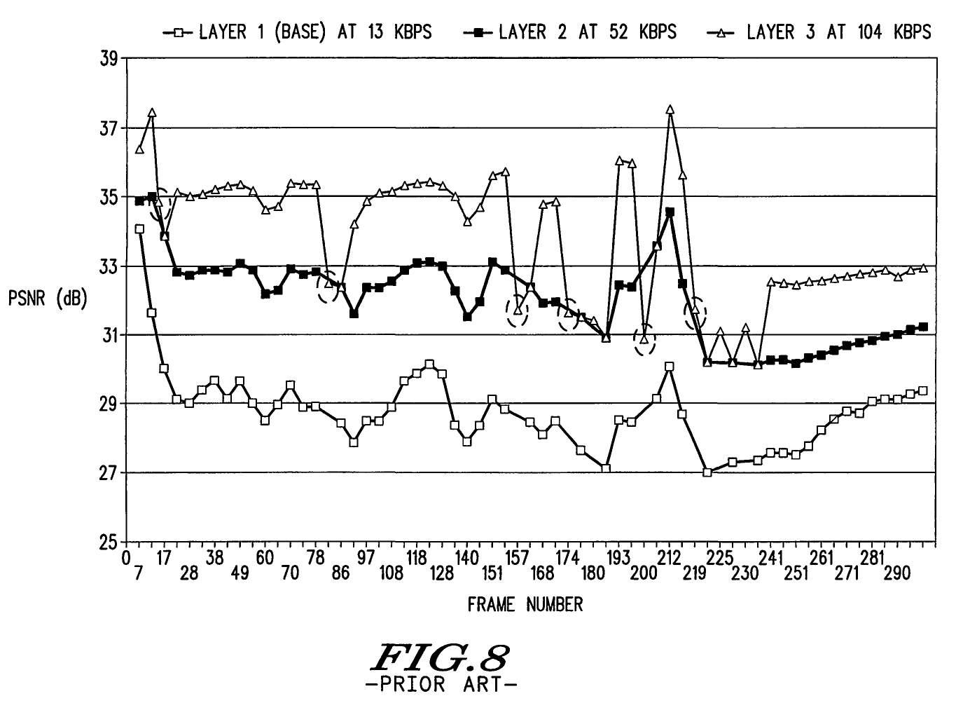

As will be appreciated, a layer 3 forward prediction can only occur according to the present invention if layer 3 includes a picture which has been enhanced over its corresponding picture in layer 2. Hence, the algorithm of FIG. 7, which supports the present invention, forces a decision as to whether a B picture is to be predicted from a previous picture in the same layer, or is determined based on a bi-directional prediction using pictures from a lower layer.

As will be appreciated, the present invention optimises the quality of the B picture by using the picture(s) from the highest possible layer for prediction. If a previous layer 3 EI picture is available, the B picture is predicted from it, using forward prediction mode only. This is because no subsequent layer 3 EI picture is available for allowing bi-directional prediction to be used. If no previous layer 3 EI picture is available, then the previous and subsequent layer 2 EI pictures are used to bi-directionally predict the picture.

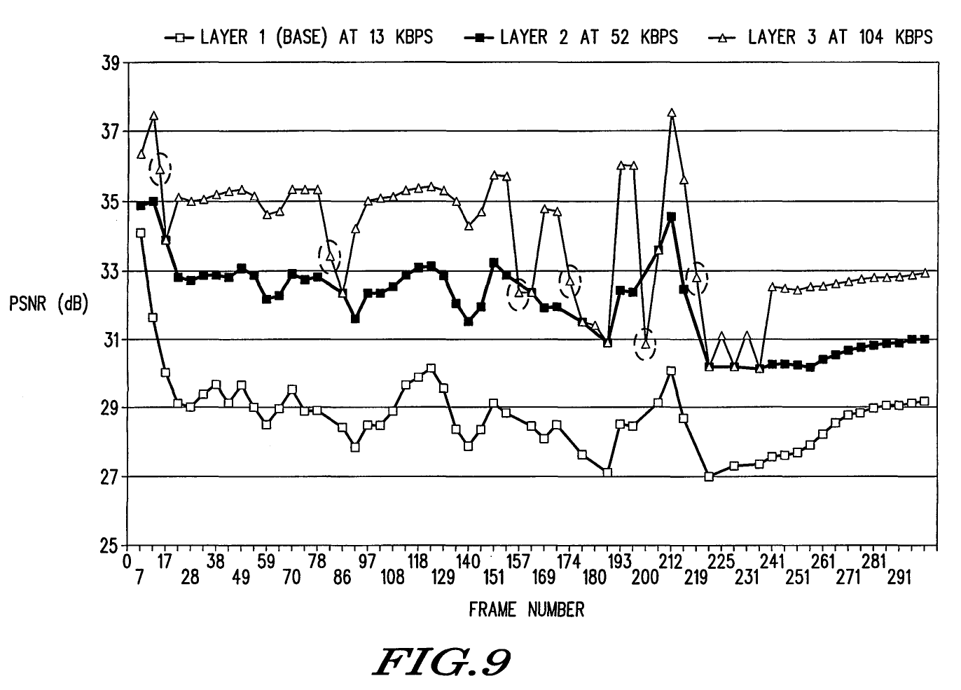

As shown by the graphs forming FIGS. 8 and 9, the present invention improves the quality (PSNR) of the B pictures by up to 1.5 dB in the cases where it is possible to predict from a previous layer 3 EI picture. The points in the graph of FIG. 9 that have been circled in dashing relate to the B pictures that have been forward predicted in accordance with the invention. These can be compared to the circled points in FIG. 8. This improvement is most noticeable at low bit rates. This is when the temporal scalability mode is not selected for every picture, and forward prediction from the layer 3 EI picture can occur more often since there are more Layer 3 EI pictures encoded.

It should also be appreciated that the improved spatial quality provided by the present invention is achieved without additional coder/decoder complexity. Furthermore, the invention is applicable to any layered scalable video transmission system, including those defined by the MPEG4 and H.263+ standards.

With reference to FIGS. 8 and 9, the invention was tested with a base layer at 13 kbps, first enhancement layer (layer 2) at 52 kbps and a second enhancement layer (layer 3) at 104 kbps.

Whilst the above method has been described generally with reference to ad-hoc systems, it will be clear to the reader that it may apply equally to communications systems which utilise a managing infrastructure. It will be equally appreciated that apparatus able to carry out the above method is included within the scope of the invention. A description of such apparatus is as follows.

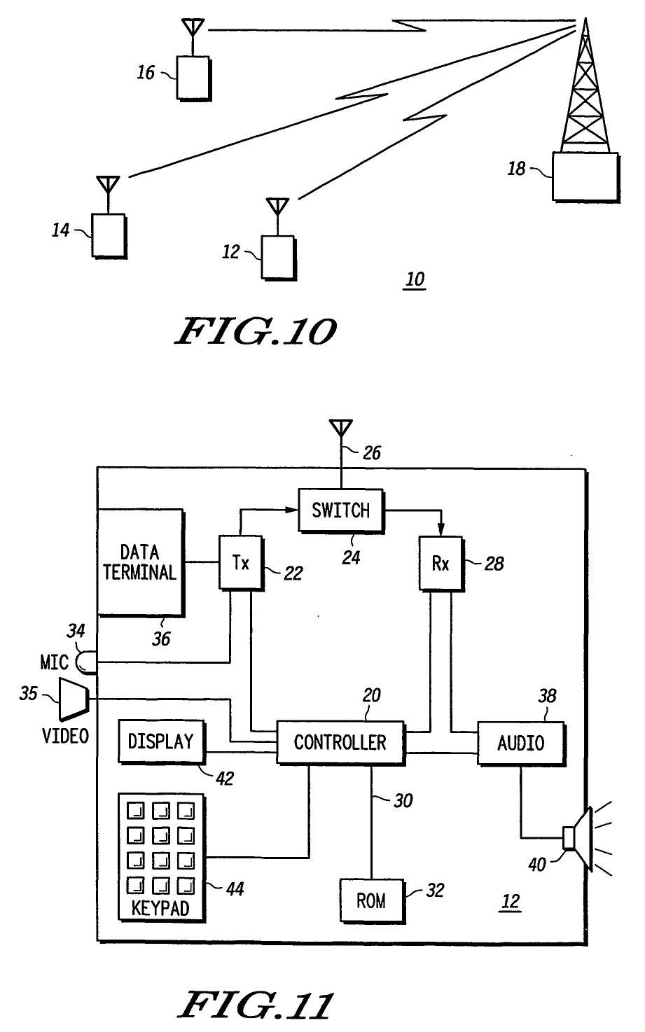

An example of a wireless communications system 10 which could take advantage of the present invention is shown in FIG. 10. Mobile stations 12, 14 and 16 of FIG. 10 can communicate with a base station 18. Mobile stations 12, 14 and 16 could be mobile telephones with video facility, video cameras or the like.

Each of the mobile stations shown in FIG. 10 can communicate through base station 18 with one or more other mobile stations. If mobile stations 12, 14 and 16 are capable of direct mode operation, then they may communicate directly with one another or with other mobile stations, without the communication link passing through base station 18.

FIG. 11 illustrates a mobile station (MS) in accordance with the present invention. The mobile station (MS) of FIG. 11 is a radio communication device, and may be either a portable- or a mobile radio, or a mobile telephone, with video facility, or a video camera with communications facility.

The mobile station 12 of FIG. 11 can transmit sound and/or video signals from a user of the mobile station. The mobile station comprises a microphone 34, which provides a sound signal, and a video camera 35, which provides a video signal, for transmission by the mobile station. The signal from the microphone is transmitted by transmission circuit 22. Transmission circuit 22 transmits via switch 24 and antenna 26.

In contrast, the video signal from camera 35 is first processed using a method according to the present invention by controller 20, which may be a microprocessor, possibly in combination with a read only memory (ROM) 32, before passing to the transmission circuit 22 for onward transmission via switch 24 and antenna 26.

ROM 32 is a permanent memory, and may be a non-volatile Electrically Erasable Programmable Read Only Memory (EEPROM). ROM 32 is connected to controller 20 via line 30.

The mobile station 12 of FIG. 11 also comprises a display 42 and keypad 44, which serve as part of the user interface circuitry of the mobile station. At least the keypad 44 portion of the user interface circuitry is activatable by the user. Voice activation of the mobile station may also be employed. Similarly, other means of interaction with a user may be used, such as for example a touch sensitive screen.

Signals received by the mobile station are routed by the switch to receiving circuitry 28. From there, the received signals are routed to controller 20 and audio processing circuitry 38. A loudspeaker 40 is connected to audio circuit 38. Loudspeaker 40 forms a further part of the user interface.

A data terminal 36 may be provided. Terminal 36 would provide a signal comprising data for transmission by transmitter circuit 22, switch 24 and antenna 26. Data received by receiving circuitry 28 may also be provided to terminal 36. The connection to enable this has been omitted from FIG. 11 for clarity of illustration.

The present invention has been described above purely by way of example, and modifications of detail may be undertaken by those skilled in the relevant art.

1. A method of optimising the quality of a picture produced by temporal scalability for an enhancement layer of a video bit stream, characterised in that the picture (B_{0.5}) is predicted based on a picture (EI₀) appearing in the highest enhancement layer of the bit stream.

2. A method of optimising the quality of a picture produced by temporal scalability for an enhancement layer of a video bit stream, characterised in that a picture (B_{0.5}) is predicted based on a single picture (EI₀) already appearing in the same enhancement layer of the bit stream.

3. A method as claimed in claim 1 or claim 2, wherein
the picture (B_{0.5}) is predicted using a forward prediction method.

4. A method as claimed in any preceding claim, wherein
the picture used for the prediction is an enhanced picture (EI₀) over the corresponding picture (EI₀) appearing in the layer below.

5. A method as claimed in any preceding claim, wherein
if an appropriate picture (EI₀) is not available to enable the prediction to occur, the predicted picture (B_{1.5}) is bi-directionally predicted, based on previous and subsequent pictures (EI₁, EI₂) in the layer below.

6. A method as claimed in any preceding claim, wherein
the method is used in a three or more layer system, and the picture (B_{0.5}) produced by temporal scalability appears in the highest layer.

7. A method according to any preceding claim, wherein
the method is used in a multi-layer hybrid SNR/temporal scalability method for improving a video bit stream.

8. A method according to any preceding claim, wherein
the method is used in a multi-layer hybrid spatial/temporal scalability method for improving a video bit stream.

9. A method according to any preceding claim, wherein
the method is used in a multi-layer hybrid object based/temporal scalability method for improving a video bit stream.

10. A system (10) or apparatus (12) for implementing a method according to any preceding claim, wherein
the system or apparatus includes processor means (20) for optimising the quality of a picture produced by temporal scalability for an enhancement layer of a video bit stream prior to transmission.

11. A system or apparatus according to claim 10,
the system (10) or apparatus (12) forming a part of a wireless or mobile communications system.

12. An apparatus according to claim 10 or claim 11, wherein
the apparatus (12) is a mobile station which incorporates a video camera (35).
